(19) United States
(12) Patent Application Publication
(10) Pub. No.: US 2011/0121944 A1
(43) Pub. Date: May 26, 2011

(54) RADIO FREQUENCY IDENTIFICATION DEVICE

(75) Inventor: Hee Bok KANG, Cheongju (KR)

(73) Assignee: Hynix Semiconductor Inc., Icheon (KR)

(21) Appl. No.: 12/792,478

(22) Filed: Jun. 2, 2010

(30) Foreign Application Priority Data
Nov. 25, 2009 (KR) 10-2009-0114413

(51) Int. Cl. H04Q 5/22

(52) U.S. Cl. 340/10.1

(57) ABSTRACT

A radio frequency identification (RFID) device senses whether electrostatic discharge (ESD) fail occurs in a RFID chip or not so as to detect a failed RFID chip. The RFID device includes an antenna configured to transmit and receive a radio frequency signal with an external reader, and an electrostatic discharge detecting unit configured to sense flowing of leakage current depending on electrostatic charge applied to the antenna and output a modulating signal corresponding to the leakage current to the antenna.

### CROSS-REFERENCE TO RELATED APPLICATION

The priority of Korean patent application No. 10-2009-0114413 filed on Nov. 25, 2009, the disclosure of which is hereby incorporated in its entirety by reference, is claimed.

### BACKGROUND OF THE INVENTION

Embodiments of the present invention relate to a radio frequency identification (RFID) device, and more specifically, to a technology for identifying an object by wirelessly transmitting and receiving a radio frequency (RF) signal to and from an external reader.

An RFID tag chip has been widely used to automatically identify objects using an RF signal. In order to automatically identify an object using the RFID tag chip, an RFID tag is attached to the object to be identified, and an RFID reader wirelessly communicates with the RFID tag of the object using a non-contact automatic identification scheme. The widespread use of these RFID technologies can overcome the shortcomings of a conventional automatic identification technology, such as a barcode and an optical character recognition technology.

In recent times, the RFID tag has been widely used in physical distribution management systems, user authentication systems, electronic money (e-money), transportation systems, and the like.

For example, the physical distribution management system generally performs the classification of goods or management of goods in stock by recording data in an integrated circuit (IC) instead of using a delivery note or tag. In another example, the user authentication system generally performs an entrance and exit management function or the like using an IC card including personal information or the like.

A non-volatile ferroelectric memory may be used in an RFID tag. Generally, a non-volatile ferroelectric memory [e.g., a ferroelectric random access memory (FeRAM)], has a data processing speed similar to that of a dynamic random access memory (DRAM). The non-volatile ferroelectric memory also preserves data even when power is turned off. This has many developers conducting intensive research into FeRAM as a next generation memory device.

The FeRAM has a similar structure to that of DRAM but uses a ferroelectric capacitor as a storage element. Ferroelectric material has high remnant polarization characteristics, such that data is not lost although an electric field is removed.

FIG. 1 is a block diagram illustrating a general RFID device. The RFID device includes an antenna unit 1, an analog unit 10, a digital unit 20, and a memory unit 30.

The antenna unit 1 receives an RF signal from an external RFID reader. The RF signal received through the antenna unit 1 is input to the analog unit 10 via antenna pads 11 and 12.

The analog unit 10 amplifies the input RF signal, and generates a power-supply voltage VDD which can then be used as a driving voltage of an RFID tag. The analog unit 10 detects an operation command signal from the input RF signal, and outputs a command signal CMD to the digital unit 20. In addition, the analog unit 10 detects the output voltage VDD and outputs a power-on reset signal POR (for controlling a reset operation) and a clock CLK to the digital unit 20.

The digital unit 20 receives the power-supply voltage VDD, the power-on reset signal POR, the clock CLK, and the command signal CMD from the analog unit 10, and outputs a response signal RP to the analog unit 10. The digital unit 20 outputs an address ADD, input/output data I/O, a control signal CTR, and the clock CLK to the memory unit 30.

The memory unit 30 reads, writes and stores data using a memory device.

In this case, the RFID device uses frequencies of various bands. In general, as the value of a frequency band is lowered, the RFID device has a slower recognition speed, operates at a shorter distance, and is less affected by the surrounding environment (e.g., disruption form WiFi, cellphones, etc.) In contrast, as the value of a frequency band is increased, the RFID device has a faster recognition speed, operates at a greater operating distance, and is considerably affected by the surrounding environment.

FIG. 2 is a flowchart illustrating an operation of the RFID device in FIG. 1.

An electrostatic charge is input through the antenna unit 1 at step S1. An electrostatic discharge (ESD) fail occurs in a RFID chip from the electrostatic charge at step S2.

An RF signal is applied through the antenna unit 1 from an external reader of the RFID chip at step S3. In the RFID chip, a leakage current flows due to the ESD fail at step S4. In this case, although the ESD fail occurs in the RFID chip by the electrostatic charge, the external reader cannot detect whether the ESD of the RFID chip fails or not in the conventional RFID device at step S5.

FIG. 3 is a view illustrating a problem of the RFID device in FIG. 1.

In FIG. 3, when an RF signal is applied through the antenna unit 1 of the RFID chip from the external reader, the leakage current flows in the RFID chip due to the ESD fail. However, the external reader does not detect whether the RFID chip fails or not.

Generally, the ESD fail may occur by an electrostatic charge during an assembly or treating process of the antenna in the RFID chip. However, other situations can arise where the ESD fail can occur. For example, an electrostatic discharge may be injected into the RFID chip intentionally during a robbery to disable the RFID chip.

However, if the conventional RFID chip fails by the electrostatic charge, the failure of the RFID device cannot be recognized by the external reader. That is, it is impossible to verify whether or not there is a failed RFID chip, which degrades the reliability during a recognizing process of objects with the conventional RFID chip. As a result, a function is needed for detecting whether an electrostatic discharge has caused a RFID chip to fail.

### BRIEF SUMMARY OF THE INVENTION

Various embodiments of the invention are directed to providing an RFID device that includes a circuit configured to sense whether an ESD fail occurs in an RFID chip or not, thereby improving the detection of a failed RFID chip.

According to an embodiment of the present invention, a radio frequency identification (RFID) device comprises: an antenna configured to communicate with an external reader using a radio frequency signal; and an electrostatic discharge (ESD) detecting unit configured to detect whether ESD fail has occurred in the RFID device by an electrostatic charge applied from the antenna and output a detection signal corresponding to the leakage current to the antenna.

### BRIEF DESCRIPTION OF THE DRAWINGS

FIG. 1 is a block diagram illustrating a general RFID device.

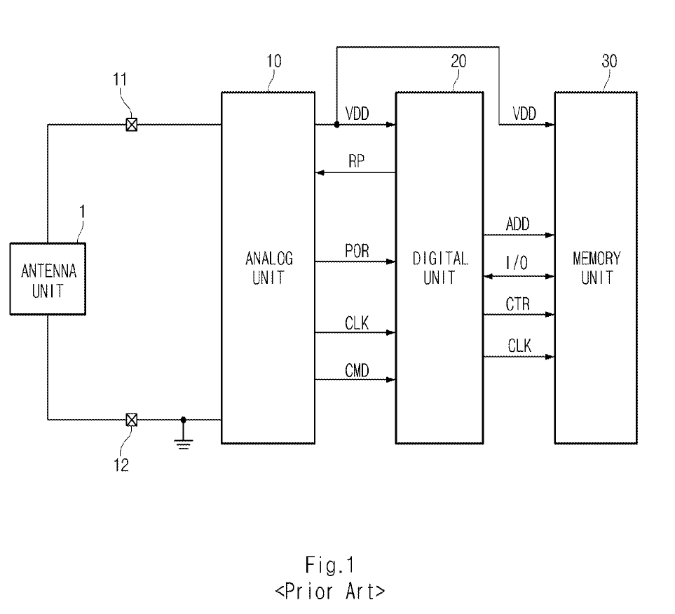

FIG. 2 is a flowchart illustrating an operation of the RFID device in FIG. 1.

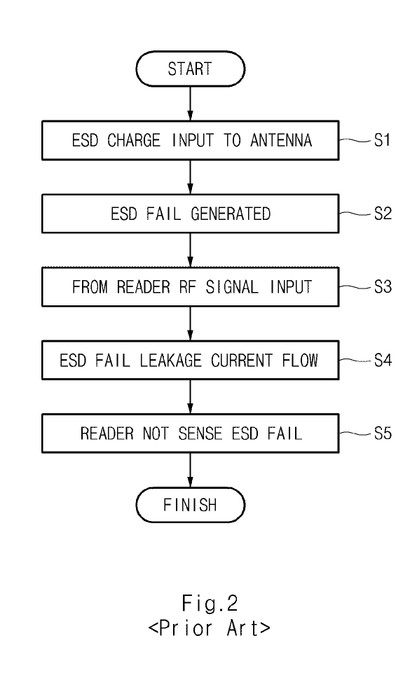

FIG. 3 is a view illustrating a problem of the RFID device in FIG. 1.

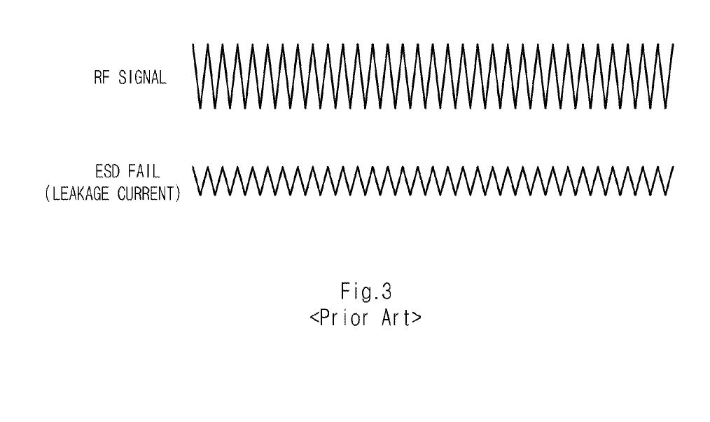

FIG. 4 is a block diagram illustrating an RFID device according to an embodiment of the present invention.

FIG. 5 is a circuit diagram illustrating an electrostatic discharge (ESD) detecting unit in FIG. 4 according to an embodiment of the present invention.

FIG. 6 is a circuit diagram illustrating a detecting signal generator in FIG. 5.

FIG. 7 is a graph illustrating an operation of the ESD detecting unit in FIG. 5.

FIG. 8 is a flowchart illustrating the operation of the ESD detecting unit in FIG. 5.

FIG. 9 is a waveform diagram illustrating the operation of the ESD detecting unit in FIG. 5.

FIG. 10 is a circuit diagram illustrating the ESD detecting unit in FIG. 4 according to another embodiment of the present invention.

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts.

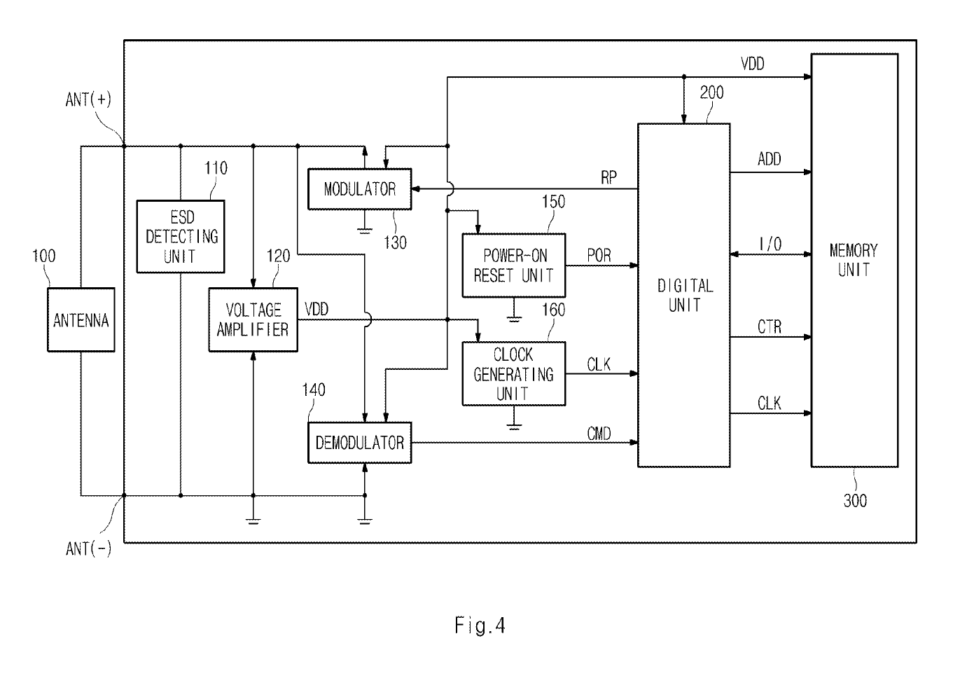

FIG. 4 is a block diagram illustrating an RFID device according to an embodiment of the present invention.

Referring to FIG. 4, the RFID device includes an antenna 100 and an RFID chip, the RFID chip containing an electrostatic discharge (ESD) detecting unit 110, a voltage amplifier 120, a modulator 130, a demodulator 140, a power-on reset unit 150, a clock generating unit 160, a digital unit 200 and a memory unit 300.

The antenna 100 receives an RF signal transmitted from an external reader. The RF signal received through the antenna 100 is input to the RFID chip through antenna pads ANT(+) and ANT(−).

The ESD detecting unit 110 detects an electrostatic charge applied to the antenna pads ANT(+) and ANT(−) to detect the ESD fail. When the ESD fail occurs in the RFID chip, the ESD detecting unit 110 generates modulating signal corresponding to a leakage current generated by the ESD fail and transmits a detection signal corresponding to the modulating signal to the external reader through the antenna 100.

The voltage amplifier 120 rectifies and boosts the RF signal applied from the antenna 100 to generate a power voltage VDD which can then be used as a driving voltage of the RFID device.

The modulator 130 modulates a response signal RP from the digital unit 200 and transmits the modulated response signal to the antenna 100. The demodulator 140 demodulates the RF signal transmitted through the antenna 100 according to the power voltage VDD output from the voltage amplifier 120, thereby outputting a command signal CMD to the digital unit 200.

The power-on reset unit 150 senses a power voltage generated from the voltage amplifier 120 and outputs a power-on reset signal POR for controlling a reset operation to the digital unit 200. The power-on reset signal POR rises with the power voltage while the power voltage is changing from a low level to a high level. When the power voltage reaches a power voltage level VDD, the power-on reset signal POR changes from a high level to a low level to reset an internal circuit of the RFID chip.

The clock generating unit 160 supplies a clock CLK for controlling an operation of the digital unit 200 to the digital unit 200 depending on the power voltage VDD generated from the voltage amplifier 120.

The digital unit 200 analyzes the command signal CMD based on the power voltage VDD, the power-on reset signal POR, and the clock CLK, and generates a control signal and processing signals. The digital unit 200 outputs the response signal RP corresponding to the control signal and the processing signals to the modulator 130. The digital unit 200 further outputs an address ADD, input/output data I/O, a control signal CTR and the clock CLK to the memory unit 300.

The memory unit 300 includes a plurality of memory cells. Each memory cell writes data in a storage element and reads out the data stored in the storage element.

For the memory unit 300, a nonvolatile ferroelectric memory (e.g., a ferroelectric random access memory (FeRAM)) is used. The FeRAM has a data processing speed similar to that of a dynamic random access memory (DRAM). The FeRAM has a similar structure to that of the DRAM, and uses a ferroelectric capacitor as a storage element. The ferroelectric capacitor includes ferroelectric material having a high remnant polarization characteristic, such that data is not lost although an electric field is removed.

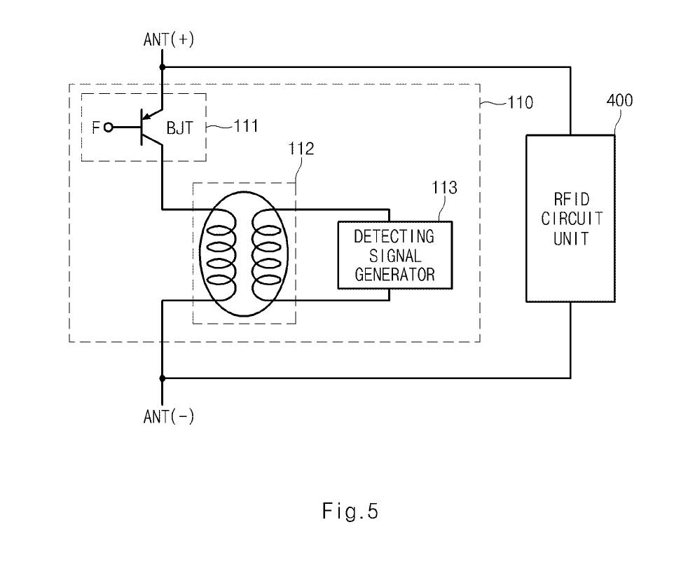

FIG. 5 is a circuit diagram illustrating the ESD detecting unit 110 in FIG. 4 according to an embodiment of the present invention. The remaining components in FIG. 4 relating to the RFID operation (minus the ESD detecting unit 110) are defined as an RFID circuit unit 400 in FIG. 5. Therefore, the RFID circuit unit 400 may include the voltage amplifier 120, the modulator 130, the demodulator 140, the power-on reset unit 150, the clock generating unit 160, the digital unit 200 and the memory unit 300.

The ESD detecting unit 110 includes an ESD element 111, a current converting unit 112, and a detecting signal generator 113.

The ESD element 111 includes a bipolar junction transistor BJT. The BJT is coupled between the antenna pad ANT(+) and the current converting unit 112. The base terminal of the BJT is coupled to a floating terminal F.

The current converting unit 112 is coupled between the ESD element 111 and the detecting signal generator 113, and senses and amplifies a leakage current flowing in the ESD element 111. The ESD element 111 and the current converting unit 112 are serially coupled between the antenna pads ANT(+) and ANT(−).

The detecting signal generator 113 converts a current signal applied from the current converting unit 112 into a detecting signal to generate a modulating signal corresponding to an ESD fail current. Then, the detection signal corresponding to the modulating signal generated from the detecting signal generator 113 is transmitted to the external reader through the current converting unit 112, the ESD element 111 and the antenna 100.

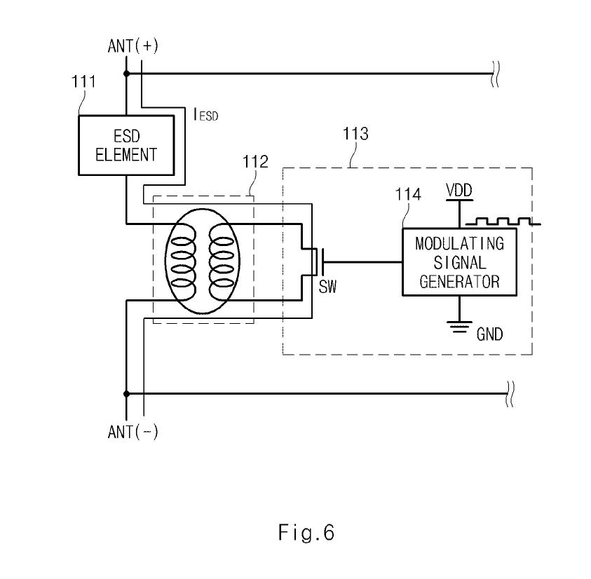

FIG. 6 is a circuit diagram illustrating the detecting signal generator 113 in FIG. 5.

The detecting signal generator 113 includes a driving switch SW and a modulating signal generator 114. The detecting signal generator 113 generates the modulating signal corresponding to the leakage current generated by the ESD fail and outputs the modulating signal to the driving switch SW. When the driving switch SW is turned on in response to the modulating signal, a current I_{ESD} flows into both ends of the antenna pads ANT(+) and ANT(−) through the ESD element 111 and the current converting unit 112.

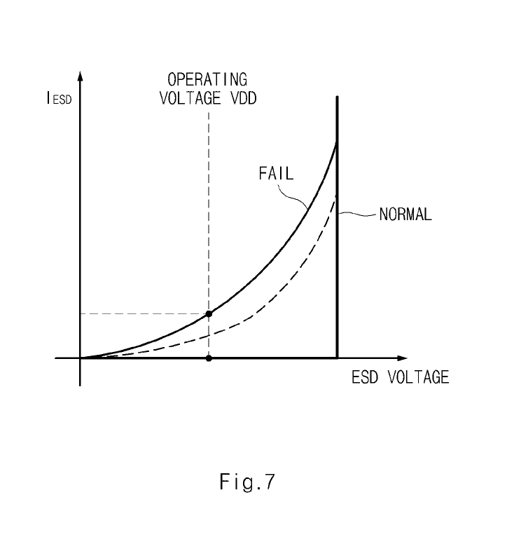

FIG. 7 is a graph illustrating an operation of the ESD detecting unit 110 in FIG. 5.

When an ESD voltage is over an operating voltage VDD (e.g., over 10V) in a normal operation, the ESD element 111 is turned on so that the current I_{ESD} flows. That is, when the ESD voltage is below a given voltage in the normal operation, the ESD element 111 is turned off so that the current I_{ESD} does not flow.

However, if the ESD element 111 is destroyed and thus cause an ESD fail to occur in the RFID chip, the current I_{ESD} flows while the ESD voltage is below the operating voltage VDD. As a result, when the ESD fail occurs in the RFID chip, a large amount of current flows into the antenna 100. Therefore, the external reader senses the current and detects whether the ESD fail occurs in the RFID chip.

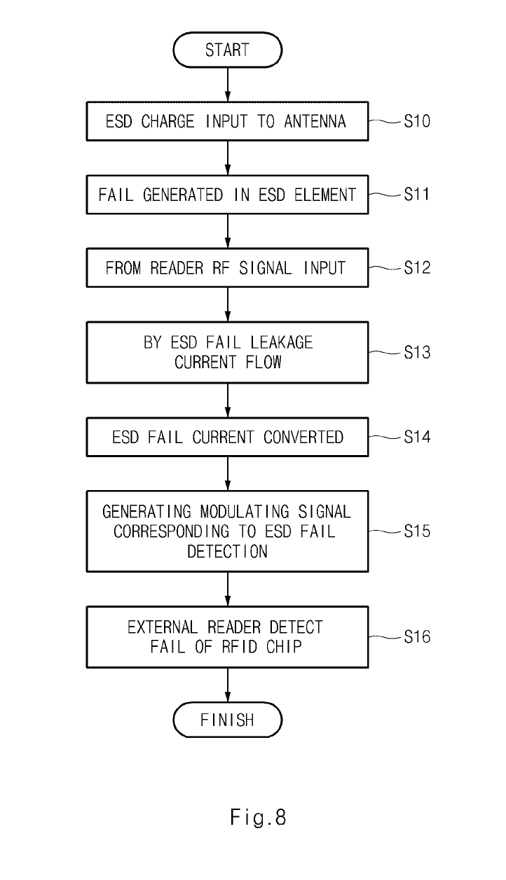

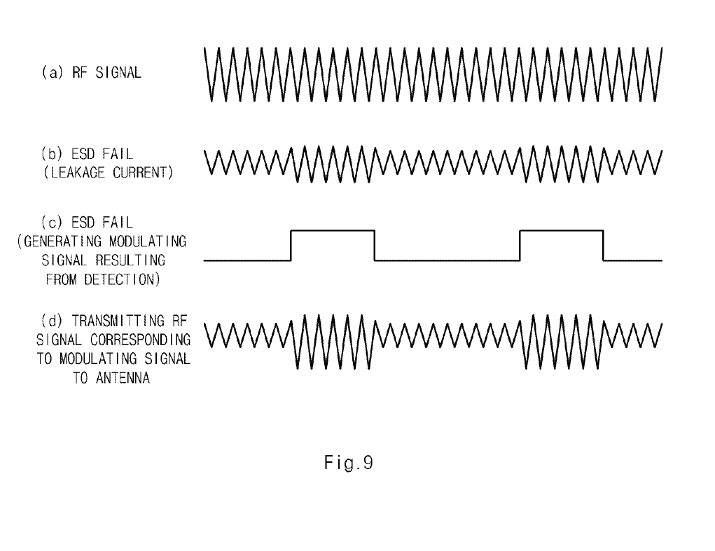

FIG. 8 is a flowchart illustrating the operation of the ESD detecting unit 110 in FIG. 5. FIG. 9 is a waveform diagram illustrating the operation of the ESD detecting unit 110 in FIG. 5.

An electrostatic charge is supplied into the RFID chip through the antenna pads ANT(+) and ANT(−) of the antenna 100 at step S10. From the electrostatic charge, the ESD fail occurs in the ESD element 111 of the RFID chip at step S11.

Then, an RF signal is input to the RFID chip from the external reader through the antenna pads ANT(+) and ANT(−) of the antenna 100 at step S12. The RF signal is applied into the RFID chip with a waveform (a) in FIG. 9. As a result, the leakage current resulting from the ESD fail of the ESD element 111 flows in the RFID chip with a waveform (b) in FIG. 9 at step S13.

The current converting unit 112 amplifies and converts the leakage current generated by the ESD fail to output the current to the detecting signal generator 113 at step S14. The detecting signal generator 113 modulates the leakage current applied from the current converting unit 112 to generate the modulating signal corresponding to the current value at step S15. The modulating signal outputted from the detecting signal generator 113 has a waveform (c) in FIG. 9.

The detecting signal generator 113 feeds the modulating signal back to the current converting unit 112. The modulating signal outputted from the ESD detecting unit 110 is transmitted to the external reader through the antenna pads ANT(+) and ANT(−). An RF signal corresponding to the modulating signal transmitted to the external reader has a waveform (d) in FIG. 9.

That is, the RF signal applied from the external reader has the constant waveform (a) in FIG. 9. However, when an electrostatic charge causes an ESD fail in the RFID, the RF signal having the irregular waveform (d) in FIG. 9 is transmitted to the external reader. As a result, the external reader senses the RF signal applied from the antenna 100 and detects whether the ESD fail occurs in the RFID chip at step S16.

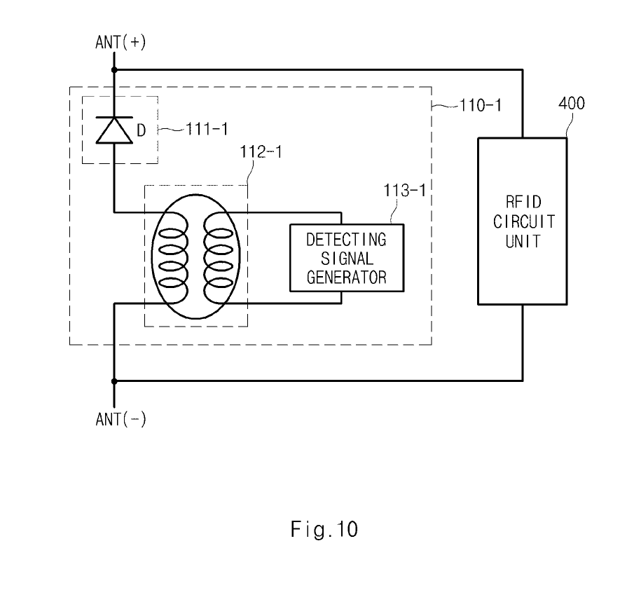

FIG. 10 is a circuit diagram illustrating the ESD detecting unit 110 in FIG. 4 according to another embodiment of the present invention. FIG. 10 shows that an ESD element 111-1 of an ESD detecting unit 110-1 includes a diode D, which is a PN-junction diode element.

The diode D is coupled backward between the antenna pad ANT(+) and the current converting unit 112-1. When a given voltage is applied from the antenna pad ANT(+), the current I_{ESD} does not flow by a characteristic of the diode D. However, when a voltage over the given voltage is applied to the diode D, the ESD element 111-1 is destroyed, so that the current I_{ESD} flows through the current converting unit 112-1 and the antenna pad ANT(−). The detecting signal generator 113-1 converts a current signal applied from the current converting unit 112-1 into a detecting signal to generate a modulating signal corresponding to an ESD fail current.

In general, an electrostatic charge is one factor for determining the reliability of a semiconductor chip, e.g., the RFID chip. The electrostatic charge can discharge into the semiconductor chip when handling the semiconductor chip or installing the semiconductor chip in a system, causing damage to the RFID chip. Therefore, the ESD circuit is required in data input/output regions of the semiconductor chip in order to protect the semiconductor chip from the static electricity. The embodiments of the present invention provide a function for sensing whether an ESD fail occurs in the RFID chip, thereby detecting whether there is a failed RFID chip.

As described above, the embodiments of the present invention provide the RFID device configured to sense whether an ESD fail has occurred in the RFID chip, thereby easily checking whether there is a failed RFID chip. As a result, the RFID device can improve the reliability of the RFID chip and the efficiency of identifying tagged objects by substituting the failed RFID chip with a new one.

The above embodiments of the present invention are illustrative and not limitative. Various alternatives and equivalents are possible. The invention is not limited by the type of deposition, etching polishing, and patterning steps describe herein. Nor is the invention limited to any specific type of semiconductor device. For example, the present invention may be implemented in a dynamic random access memory (DRAM) device or non volatile memory device. Other additions, subtractions, or modifications are obvious in view of the present disclosure and are intended to fall within the scope of the appended claims.

What is claimed is:

1. A radio frequency identification (RFID) device comprising:
an antenna configured to communicate with an external reader using a radio frequency signal; and
an electrostatic discharge (ESD) detecting unit configured to detect whether ESD fail has occurred in the RFID device by an electrostatic charge applied from the antenna and output a detection signal corresponding the a leakage current to the antenna.

2. The RFID device according to claim 1, wherein the ESD detecting unit is coupled to first and second ends of an antenna pad to receive the radio frequency signal.

3. The RFID device according to claim 1, wherein the electrostatic discharge detecting unit includes:
an ESD element configured to receive the electrostatic charge;
a current converting unit configured to sense and amplify a leakage current flowing through the ESD element; and
a detecting signal generator configured to generate and output the detection signal corresponding to the leakage current to the current converting unit.

4. The RFID device according to claim 3, wherein the ESD element includes a bipolar junction transistor.

5. The RFID device according to claim 4, wherein the bipolar junction transistor is provided between the antenna and the current converting unit and has a base terminal coupled to a floating terminal.

6. The RFID device according to claim 3, wherein the ESD element includes a diode.

7. The RFID device according to claim 6, wherein the diode is a PN-junction diode.

8. The RFID device according to claim 6, wherein the diode is coupled backward between the antenna and the current converting unit.

9. The RFID device according to claim 3, wherein the detecting signal generator includes:
a modulating signal generator configured to generate a modulating signal; and
a driving switch configured to perform a switching operation in response to the modulating signal and output the detection signal to the current converting unit.

10. The RFID device according to claim 1, further comprising:
a voltage amplifying unit coupled to the antenna and configured to generate a power voltage;
a demodulating unit configured to demodulate the radio frequency signal and generate a command signal;
a digital unit configured to generate processing signals in response to the command signal;
a memory unit configured to perform read and write operations of data in response to the processing signals; and
a modulating unit configured to modulate a response signal applied from the digital unit.

11. The RFID device according to claim 10, further comprising:
a power-on reset unit configured to output a power-on reset signal to the digital unit depending on the power voltage; and
a clock generating unit configured to generate and output a clock signal to the digital unit depending on the power voltage.

12. The RFID device according to claim 10, wherein the memory unit includes a nonvolatile ferroelectric memory.
